(19) United States
(12) Patent Application Publication
(10) Pub. No.: US 2026/0309519 A1
(43) Pub. Date: Oct. 8, 2026

(54) DETECTION SYSTEM, DETECTION METHOD, AND ANALYSIS DEVICE

(71) Applicants: NTT, Inc., Tokyo (JP); THE UNIVERSITY OF TOKYO, Tokyo (JP)

(72) Inventors: Masaki WADA, Musashino-shi, Tokyo (JP); Takashi MATSUI, Musashino-shi, Tokyo (JP); Hiroyuki IIDA, Musashino-shi, Tokyo (JP); Kazuhide NAKAJIMA, Musashino-shi, Tokyo (JP); Hideaki MURAYAMA, Bunkyo-ku, Tokyo (JP); Ryota WADA, Bunkyo-ku, Tokyo (JP)

(73) Assignees: NTT, Inc., Tokyo (JP); THE UNIVERSITY OF TOKYO, Tokyo (JP)

(21) Appl. No.: 19/480,028

(22) PCT Filed: Apr. 25, 2024
(86) PCT No.: PCT/JP2024/016267

§ 371 Date: Oct. 30, 2025

(30) Foreign Application Priority Data
May 1, 2023 (JP) 2023-075423

(51) Int. Cl. G01D 5/353

(52) U.S. Cl. CPC G01D 5/353

(57) ABSTRACT

A detection system, a detection method, and an analysis device for detecting a linear structure. The detection system uses an optical fiber cable including a multi-core optical fiber and having different cross sectional lengths in a vertical direction and a horizontal direction. The detection system includes a strain distribution measurement device to measure a strain distribution along an extending direction of the multi-core optical fiber before the optical fiber cable is installed into the linear structure, and to measure a strain distribution along an extending direction of the multi-core optical fiber after the optical fiber cable is installed into the linear structure. Further, there is an analysis device to calculate a shape of the optical fiber cable using a difference between the strain distribution before the optical fiber cable is installed and the strain distribution after the optical fiber cable is installed.

### TECHNICAL FIELD

This disclosure relates to a detection system, a detection method, and an analysis device.

### BACKGROUND ART

Linear structures, such as pipelines, where communication cables or the like are installed have been deteriorating due to long-term use, disasters, accidents, construction, or the like. In order to repair a deteriorated linear structure, it is necessary to specify a deterioration position. However, identification of the deterioration position by visual inspection requires complex operation. In addition, an installation position of a linear structure cannot be accurately confirmed on a map. For example, the installation position of the linear structure may not be recorded correctly at the time of construction, or map information may change due to large-scale construction after the linear structure has been installed.

Therefore, Non-patent Literature 1 discloses a technology to record an underground situation on a map by driving a vehicle equipped with a ground penetrating radar that detects buried objects by electromagnetic waves. Non-patent Literature 2 discloses a technology to identify the position of communication facilities by remotely detecting vibrations of optical cables by applying vibrations from the ground.

### CITATION LIST

### Non-Patent Literature

[Non-patent Literature 1] “New App Streamlines Test Drilling by Creating 3D Models of Underground Conditions, Can be Integrated with Map Information for Management”, Maintenance and Resilience OSAKA 2021, [Searched on Jan. 4, 2023], Internet <URL: https://built.itmedia.co.jp/bt/articles/2108/24/news030.html>
[Non-patent Literature 2] “About Starting Operation of Communication Facility Maintenance by Optical Sensing Technology for the IOWN Era”, NTT EAST, [Searched on Jan. 4, 2023], Internet <URL: https://www.ntt-east.co.jp/release/detail/20220516_01.htm>

### SUMMARY OF INVENTION

### Problems to be Solved by Invention

However, in the method described in Non-patent Literature 1 and 2, it is necessary to estimate the position of a linear structure to a certain degree, and then to perform a radar survey or application of vibration. Therefore, there is a problem that it is not possible to accurately detect an underground situation when information regarding equipment such as a communication cable is insufficient.

The present disclosure has been made in view of the circumstances above, and it is an object of the present disclosure to provide a detection system, a detection method, and an analysis device capable of detecting a linear structure.

### Solution to Solve Problems

In one aspect of the present disclosure, a detection system for detecting a linear structure uses an optical fiber cable including a multi-core optical fiber and having different cross sectional lengths in a vertical direction and a horizontal direction. The detection system includes: a strain distribution measurement device configured to measure a strain distribution along an extending direction of the multi-core optical fiber before the optical fiber cable is installed into the linear structure, and to measure a strain distribution along an extending direction of the multi-core optical fiber after the optical fiber cable is installed in the linear structure; and an analysis device configured to calculate a shape of the optical fiber cable using a difference between the strain distribution before the optical fiber cable is installed and the strain distribution after the optical fiber cable is installed, and to calculate an installation position of the linear structure based on the shape of the optical fiber cable.

In one aspect of the present disclosure, a detection method for detecting a linear structure uses an optical fiber cable including a multi-core optical fiber and having different cross sectional lengths in a vertical direction and a horizontal direction. The method for detecting a linear structure includes: measuring a strain distribution along an extending direction of the multi-core optical fiber before the optical fiber cable is installed into the linear structure, by using a strain distribution measurement device, measuring a strain distribution along an extending direction of the multi-core optical fiber after the optical fiber cable is installed into the linear structure, by using the strain distribution measurement device; and calculating a shape of the optical fiber cable using a difference between the strain distribution before the optical fiber cable is installed and the strain distribution after the optical fiber cable is installed, and calculating an installation position of the linear structure based on the shape of the optical fiber cable, by using an analysis device.

In one aspect of the present disclosure, an analysis device uses an optical fiber cable including a multi-core optical fiber and having different cross sectional lengths in a vertical direction and a horizontal direction. The analysis device includes a reception unit configured to receive a strain distribution along an extending direction of the multi-core optical fiber measured before the optical fiber cable is installed into the linear structure, and to receive a strain distribution along an extending direction of the multi-core optical fiber measured after the optical fiber cable is installed into the linear structure; and an arithmetic unit configured to calculate a shape of the optical fiber cable using a difference between the strain distribution before the optical fiber cable is installed and the strain distribution after the optical fiber cable is installed, and to calculate an installation position of the linear structure based on the shape of the optical fiber cable.

### Effects of Invention

According to the present disclosure, it is possible to provide a detection system, a detection method, and an analysis device capable of detecting a linear structure.

### BRIEF DESCRIPTION OF DRAWINGS

FIG. 1 is a diagram illustrating a configuration of a detection system according to the present embodiment.

FIG. 2 is a diagram illustrating an example of an optical fiber and an optical fiber cable.

FIG. 3 is a diagram illustrating an example of an optical fiber and an optical fiber cable.

FIG. 4 is a diagram illustrating a method for detecting a linear structure.

FIG. 5 is a diagram illustrating a method of measuring the shape of an MCF and a linear structure.

FIG. 6 is a diagram illustrating a positional relationship, or the like, of cores.

FIG. 7 is a diagram illustrating a hardware configuration of an analysis device.

### DESCRIPTION OF EMBODIMENTS

An embodiment of the present disclosure will be described below with reference to the drawings.

### Summary of Present Disclosure

In the present disclosure, an optical fiber cable including one or more multi-core optical fibers (MCFs) and having a cross section with different lengths in a vertical direction and a horizontal direction is inserted into a linear structure to be measured; strain distributions of the MCFs along the longitudinal direction are measured before and after the insertion; and an installation position of the linear structure or the like is detected based on a difference between the measured each strain distributions.

In this manner, the optical fiber cable including the MCFs is inserted into the linear structure to be measured, and the strain distributions are measured, so that the installation position of the linear structure can be reliably detected. In particular, the length of the optical fiber cable in the vertical direction and the length in the horizontal direction are different in the cross section, so that the axial rotation of an optical fiber cable 1 is reduced when the optical fiber cable is inserted into the linear structure, and the installation position of the linear structure can be accurately detected.

### [Configuration of Detection System]

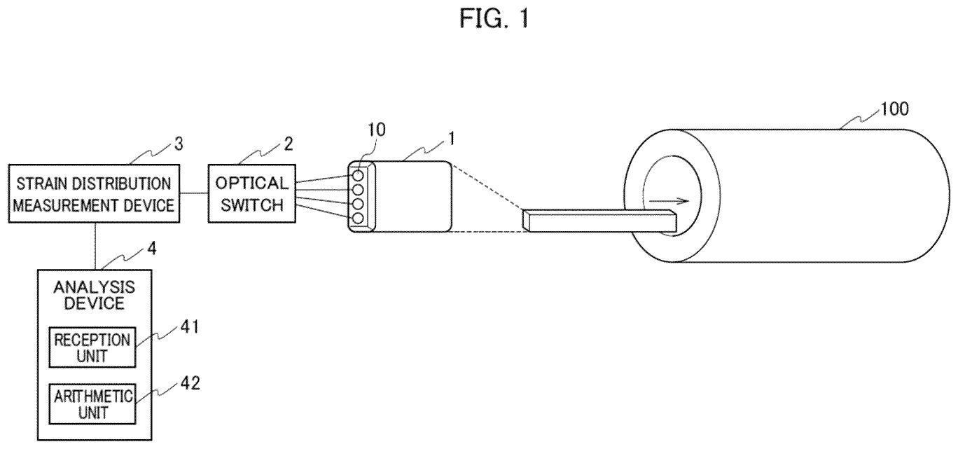

FIG. 1 is a diagram illustrating a configuration of a detection system according to the present embodiment.

The detection system is a system configured to install (insert, conduct) the optical fiber cable 1 into a linear structure 100 to be detected, and to detect an installation position or the like of the linear structure 100 using the optical fiber cable 1. The linear structure 100 is, for example, a structure in which various cables for electricity, gas, water, communication, or the like are installed. Examples of the linear structure 100 include ducts, conduits, and paths provided on the ground, underground, on a bridge, undersea, or other locations.

As illustrated in FIG. 1, the detection system includes the optical fiber cable 1, an optical switch 2, a strain distribution measurement device 3, and an analysis device 4.

The optical fiber cable 1 includes one or more optical fibers 10, and is inserted into the linear structure 100 in an extending direction of the linear structure 100. The optical fiber cable 1 includes at least one MCF including a plurality of cores.

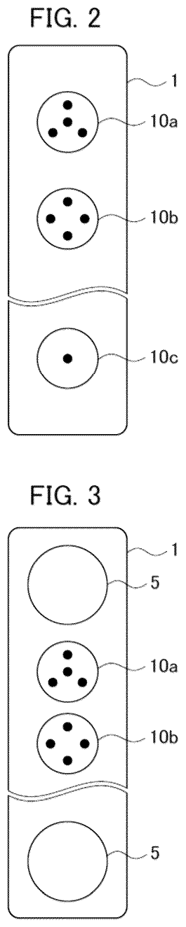

As illustrated in FIG. 2, the optical fiber 10 is, for example, an MCF 10a including four cores in and outside of a center of the cross section, an MCF 10b including four cores in a square lattice shape outside of the center of the cross section, and a single-mode optical fiber 10c including one core in the center of the cross section. The MCFs may include, but need not include, a core in the center of the cross section.

As illustrated in FIG. 2, the optical fiber cable 1 has a rectangular shape having different lengths in a vertical direction and a horizontal direction in the cross section, so that it covers and fixes an entire side of the one or more optical fibers 10 including the MCFs.

As described above, the optical fiber cable 1 has different lengths in a vertical direction and a horizontal direction in cross section, so that axial rotation of the optical fiber cable 1 is reduced during or after installation of the optical fiber cable 1 into the linear structure 100. As a result, unintentional torsion does not occur in the optical fiber 10, and it is not necessary to consider torsion in the analysis device 4. Therefore, a special device or an installation method in consideration of torsion is unnecessary. As a result, detection accuracy of an installation position or the like can be improved.

In order to further reduce the axial rotation of the optical fiber cable 1, a tensile strength member 5 may be mounted inside both ends of the optical fiber cable 1, as illustrated in FIG. 3. Thus, the axial rotation of the optical fiber cable 1 can be further reduced by mounting the tensile strength member 5 inside both ends of the optical fiber cable 1, so that detection accuracy of the installation position or the like can be further improved.

When a plurality of optical fibers 10 are implemented in one optical fiber cable 1, as illustrated in FIGS. 2 and 3, the plurality of optical fibers 10a to 10c are arranged and fixed on the same straight line (in line) in the cross section of the optical fiber cable 1.

As described above, the plurality of optical fibers 10 are arranged and fixed on the same straight line, so that neither unintentional torsions of the optical fibers 10 during and after installation the optical fiber cable 1 into the linear structure 100, nor inherent torsions differing among a plurality of the optical fibers 10, occur. As a result, detection accuracy of the installation position or the like can be further improved.

Examples of the optical fiber cable 1 include a multi-core optical fiber (tape optical fiber) in which the plurality of optical fibers 10 are arranged in a straight horizontal line. The plurality of optical fibers 10 may be arranged in three vertical rows by two horizontal rows.

There are preferably a plurality of the MCFs. This is because detection accuracy of the installation position and the like can be improved by mutually analyzing results in the analysis device 4.

Further, a clad diameter of the MCFs is preferably 125±1 μm. This is because existing optical fiber tape cores and optical fiber cable structures can be utilized.

The number of cores of the MCFs is preferably four or more, including three detection cores and one communication core. Although two detection cores may be sufficient, it is preferable to have three or more detection cores to obtain a predetermined detection accuracy.

Further, the optical fiber cable 1 preferably includes both the MCFs, and a single-mode optical fiber including one core at the center of the cross section. The differential strain obtained from the single-mode optical fiber is regarded as axial strain, and the axial strain obtained from the measured strain of the MCFs is corrected by using the strain axis in the analysis device 4, thereby improving the detection accuracy of the installation position or the like.

Furthermore, a jacket of the optical fiber cable 1 is preferably a material having a low friction coefficient, so that it can be smoothly inserted into an existing linear structure 100 where inner pipes, microducts, cables, or the like are installed.

In addition, it is preferable that the optical fiber cable 1 is inserted in advance for a system such as an offshore power generation cable system, into which it is difficult to introduce the optical fiber cable 1 at a later point.

Next, components of the detection system will be described with reference to FIG. 1.

The optical switch 2 is a device configured to be connected to one end of the one or more optical fibers 10, and to select one optical fiber 10 from the one or more optical fibers 10.

The strain distribution measurement device 3 is a device configured to be connected to the optical switch 2, and to measure strain distribution of the optical fibers 10 selected by the optical switch 2. The strain distribution measurement device 3 is, for example, a Brillouin OTDR (Brillouin Optical Time Domain Reflectometer: B-OTDR).

For example, the strain distribution measurement device 3 measures the strain distribution along extension directions of the MCFs before the optical fiber cable 1 is installed into the linear structure 100, and measures strain distributions along the extension directions of the MCFs after the optical fiber cable 1 is installed into the linear structure 100.

For example, the strain distribution measurement device 3 measures strain distributions along the extension directions of the MCFs at two or more different timings after the optical fiber cable 1 is installed into the linear structure 100.

The analysis device 4 includes a reception unit 41 which is connected to the strain distribution measurement device 3, and which receives the strain distribution data from the strain distribution measurement device 3, and an arithmetic unit 42 which calculates an installation position or the like of the linear structure 100 using the strain distribution data.

Specifically, the analysis device 4 measures a shape, a shape change, an installation position, or the like of the optical fibers 10 using the measurement result of the strain distributions of the optical fibers 10 performed by the strain distribution measurement device 3; and analyzes a shape, a shape change, an installation position, soundness, presence of abnormality, failure prediction, or the like of the linear structure 100 based on the measurement result of the optical fibers 10.

For example, the analysis device 4 calculates the shape of the MCF using a difference between the strain distribution before installation and the strain distribution after installation, and calculates the installation position of the linear structure 100 based on the shape of the MCF.

For example, the analysis device 4 calculates the presence or absence of abnormality and the installation position of the linear structure 100 based on the difference between the strain distributions measured at two or more different timings after the optical fiber cable 1 is installed into the linear structure 100.

### [Detection Method for Linear Structure]

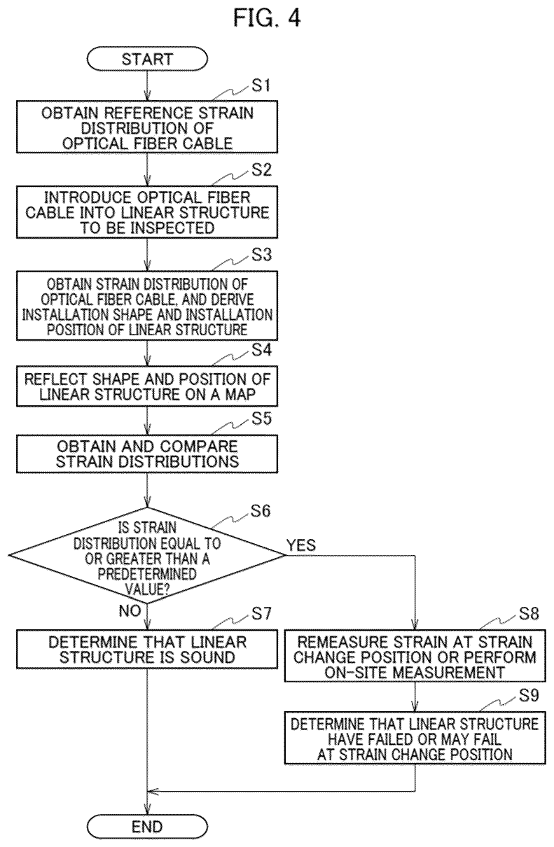

FIG. 4 is a diagram illustrating a detection method for a linear structure.

### Step S1;

Before the optical fiber cable 1 is inserted into the linear structure 100, the strain distribution measurement device 3 measures a strain distribution along extending directions of the MCFs included in the optical fiber cable 1. Then, the strain distribution measurement device 3 sets the strain distribution as a reference strain distribution in a reference state. Reference state means a state in which the shape of the optical fiber cable 1 is known, such as when the optical fiber cable 1 is shipped.

### Step S2;

A user inserts the optical fiber cable 1 including the one or more optical fibers 10 including the MCFs into the linear structure 100 by manual operation or using an optional introduction device, and fixes the optical fiber cable 1 to the linear structure 100.

### Step S3;

After the optical fiber cable 1 is inserted into the linear structure 100, the strain distribution measurement device 3 measures the strain distribution along the extending directions of the MCFs included in the optical fiber cable 1. Thereafter, the analysis device 4 measures the shape of the MCFs using the difference between the reference strain distribution measured in step S1 and the strain distribution measured in step S3, and calculates the installation shape and the installation position of the linear structure 100 based on the shape of the MCFs.

### Step S4;

The analysis device 4 describes the calculated installation shape and installation position of the linear structure 100 on a map.

### Step S5;

The strain distribution measurement device 3 remeasures the strain distribution along the extension directions of the MCFs after a certain time elapses (for example, one year later) or after a predetermined event occurs (for example, after an earthquake). Thereafter, the analysis device 4 compares a past strain distribution measured in step S3 with a remeasured current strain distribution.

### Step S6;

The analysis device 4 determines whether the difference between the past strain distribution and the present strain distribution is equal to or greater than a predetermined value. The predetermined value is an index value (for example, 1% or more) predetermined to determine whether the linear structure 100 is normal or abnormal.

### Step S7;

If the difference between the past strain distribution and the present strain distribution is not equal to or greater than the predetermined value, the analysis device 4 determines that the linear structure 100 is sound. Thereafter, the process ends.

### Step S8;

If the difference between the past strain distribution and the present strain distribution is equal to or greater than the predetermined value, the analysis device 4 remeasures the strain at the position where the difference is equal to or greater than the predetermined value. Then, the analysis device 4 remeasures the shapes of the MCFs using the result of the remeasurement, and recalculates the installation shape and the installation position of the linear structure 100 based on the remeasured shapes of the MCFs. At this point, the user may perform a field measurement at the position where the strain was remeasured.

### Step S9;

After step S8, the analysis device 4 determines that the MCFs and the linear structure 100 have failed or may fail at the position where the strain was remeasured. Thereafter, the process ends.

### [Shape Measurement Method of MCFs and Linear Structure]

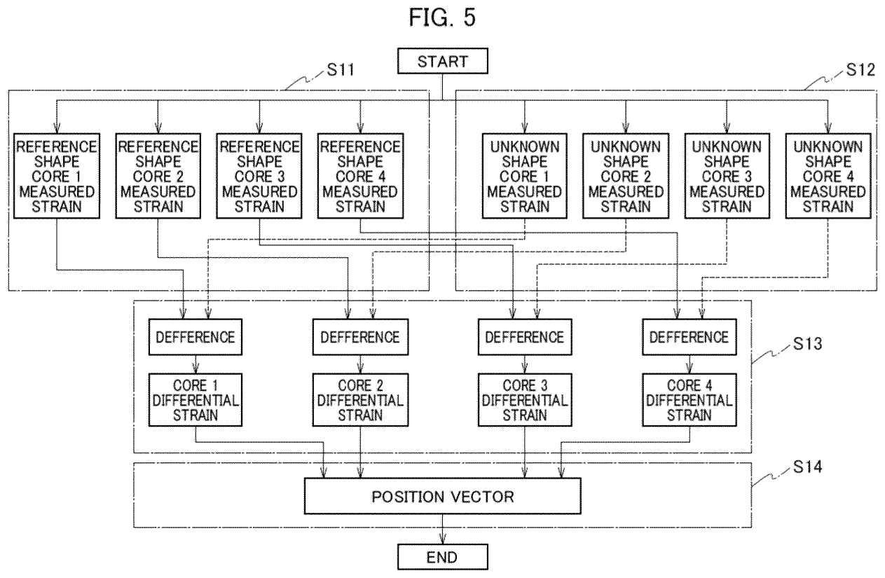

FIG. 5 is a diagram illustrating a method of measuring shapes of MCFs and a linear structure. The method is executed in steps S1 and S3 of FIG. 4, and can be repeated at regular time intervals. In this method, MCFs have no core at the center of the cross section, and four cores outside the center of the cross section are provided in a square grid shape. The four cores are arranged in a square grid shape with approximately equal intervals on the same circumference at approximately the same distance from the center of the cross section of the clad.

### Step S11;

The strain distribution measurement device 3 measures the strain distribution characteristic (strain at each point along the extension direction) of each core of the MCFs in a predetermined state (for example, the reference state of step S1). If necessary, the strain distribution measurement device 3 measures the strain distribution characteristic of each core of another optical fiber. Thus, the analysis device 4 acquires strain distribution data along the extension direction of each core in a reference shape.

### Step S12;

The strain distribution measurement device 3 measures the strain distribution characteristics (strain at each point along the extension direction) of each core of the MCFs in any state (for example, in step S3). If the accuracy required for the shape analysis cannot be obtained, the strain distribution measurement device 3 measures the strain distribution characteristics of other optical fibers. Thus, the analysis device 4 acquires the strain distribution data in the extension direction of each core in an unknown shape.

### Step S13;

The analysis device 4 calculates a differential strain between the strain distribution data in the reference shape acquired in step S11, and the strain distribution data in the unknown shape acquired in step S12.

Here, a differential strain εᵢ of each core Cᵢ (i is a number from 1 to 4) of the MCF is the sum of a bending strain ε_{b} due to bending of the MCF and an axial strain εₐ in the MCF extending direction. However, the axial strain &a is constant within the MCF, so that it is a common value for each core Cᵢ. Therefore, the differential strain Ei of each core Cᵢ is expressed by equation (1).

$${ε}_{i} = {ε}_{b , i} + {ε}_{a} \qquad ( 1 )$$

The bending strain ε_{b}, i of each core Cᵢ is expressed by equation (2).

$${ε}_{b , i} = {r}_{i} \cdot κ \cdot cos ( {α}_{i} + β ) \qquad ( 2 )$$

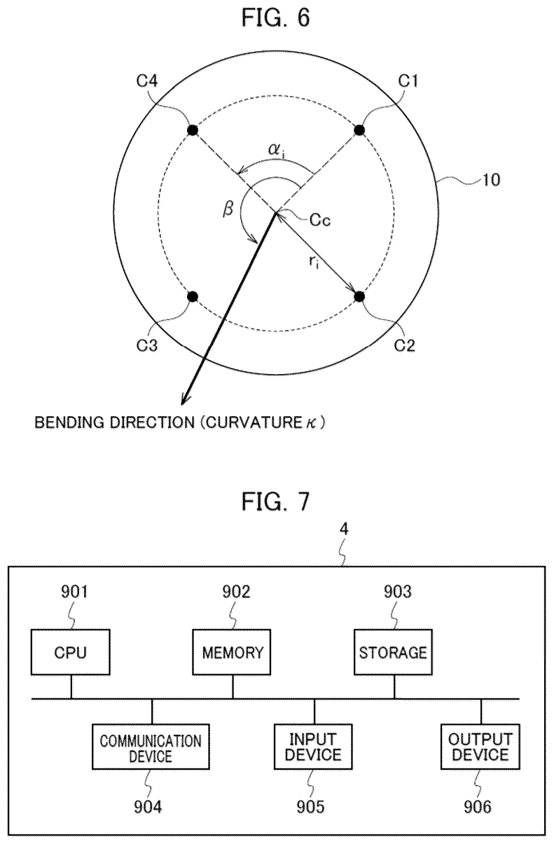

As illustrated in FIG. 6, rᵢ is a linear distance from a center C_{c} of a cross section to each core Cᵢ. αᵢ is an angle formed by a line connecting the core Cᵢ and the center C_{c} of the cross section and a line connecting a core C adjacent to the core Cᵢ and the center C_{c} of the cross section. κ is a curvature added to the MCF 10 and is a common value for each core Cᵢ. β is the bending angle added to the MCF 10 and is a common value for each core Cᵢ.

In this example, there are four cores, and simultaneous equations with four unknowns can be obtained for equation (1) in which equation (2) is substituted. The analysis device 4 substitutes the calculated differential strain Ei of each core Cᵢ of the MCF, the linear distance rᵢ from the center C_{c} of the cross section to each core Cᵢ, and the angle αᵢ between adjacent cores into equation (1). Then, the analysis device 4 uses the fact that the axial strain εₐ, the curvature κ, and the bending angle β do not depend on any core, and solves for the curvature κ and the bending angle β by an analytical method such as a regression analysis.

### Step S14;

The analysis device 4 derives a position vector at each point where the strain was measured, from the curvature κ and the bending angle β obtained in step S13, using the Frenet-Serret integral formula. By continuously obtaining position vectors from a measurement start point, it is possible to determine in which direction and how much an MCF is deformed at each point in the extending direction, and to obtain the three-dimensional shape over the entire length of the MCF and the shape change from the reference state.

Then, the analysis device 4 calculates the shape, a shape change, an installation position, or the like of the linear structure 100 based on a three-dimensional shape and a shape change of the MCF. For example, the analysis device 4 outputs the three-dimensional shape and a shape change of the MCF as the calculation result of the shape and shape change of the linear structure 100. At this point, the analysis device 4 may use a map or the like in which the position information of the linear structure 100 is provided.

### Modified Example 1

A case where an MCF with a core at the center of the cross section is used will be additionally described.

In this case, the measured strain of the center core is not affected by bending, so that the equation (1) related to the center core Cᵢ becomes εᵢ=εₐ.

In this case, the analysis device 4 determines the position vector by solving the simultaneous equations of formula (1) in which the differential strain between the measured strain at the center core in the reference shape and the measured strain at the center core when the shape is unknown is defined as the axial strain εₐ′, and the axial strain εₐ′ is subtracted from the differential strain εᵢ at a non-center core.

### Modified Example 2

When a single-mode optical fiber with one core at the center of the cross section is included in addition to the MCF, the analysis device 4 defines the differential strain obtained from the single-mode optical fiber as the axial strain εₐ″, and corrects the axial strain εₐ obtained from the measured strain of the MCF by using the axial strain εₐ″. As a result, accuracy of analysis of the installation position or the like can be further improved.

### [Effect]

According to the present embodiment, the optical fiber cable 1 including the MCF is inserted into the linear structure 100 to be detected, and the installation position or the like of the linear structure 100 is calculated, so that the position of the linear structure 100, which is located underground, undersea, or in another location and cannot be directly seen, can be detected nondestructively and remotely. The position of the linear structure 100 can be specified remotely without prior positional information.

Furthermore, according to the present embodiment, the length of the optical fiber cable 1 in the vertical direction and the length in the horizontal direction are different in cross section, so that axial rotation of the optical fiber cable 1 is reduced at the time of installation or after the installation into the linear structure 100. As a result, unintentional torsions do not occur in the optical fibers 10, and it is not necessary to consider the torsion in the analysis device 4. Therefore, a special device or installation method for considering the torsion is unnecessary. As a result, detection accuracy of the installation position or the like can be improved.

According to the present embodiment, after the optical fiber cable 1 is inserted into the linear structure 100 and fixed, the analysis device 4 calculates the presence or absence of abnormality and the installation position of the linear structure 100 based on a difference magnitude of each strain distribution measured at two or more different timings. Therefore, it is possible to detect signs of failure of the linear structure 100, failures due to aging degradation, accidents, or the like nondestructively and remotely. Signs of failure can be detected without going to a site and without prior positional information of the linear structure 100. However, with the methods of Non-Patent Literatures 1 and 2, it is difficult to detect changes of the linear structure in a timely manner, and an on-site inspection is required.

According to the present embodiment, a plurality of the optical fibers 10 are arranged and fixed on the same line, so that neither unintentional torsions of the optical fibers 10 during and after the installation the optical fiber cable 1 into the linear structure 100, nor inherent torsions differing among a plurality of the optical fibers 10 occur. As a result, detection accuracy of the installation position or the like can be further improved.

According to the present embodiment, the MCFs have a cladding diameter of 125±1 μm, so that existing optical fiber tape core wires and optical fiber cable structures can be utilized. As a result, the installation position or the like can be detected more easily.

According to the present embodiment, the MCFs have four or more cores, so that they can be utilized not only for detection but also for communication. According to the present embodiment, the installation position or the like of the linear structure is calculated using the strain distribution of the MCFs and the strain distribution of the single-mode optical fiber, so it is possible to further improve detection accuracy of the installation position and the like.

### [Other]

The present disclosure is not limited to the embodiments above. The present disclosure can be modified in many ways within the scope of the present disclosure.

The analysis device 4 of the present embodiment described above can be implemented, for example, using a general-purpose computer system including a CPU 901, a memory 902, a storage 903, a communication device 904, an input device 905, and an output device 906, as illustrated in FIG. 7.

The memory 902 and the storage 903 are storage devices. In the computer system, each function of the analysis device 4 is implemented by the CPU 901 executing a predetermined program loaded in the memory 902.

The analysis device 4 may be implemented by one computer. The analysis device 4 may be implemented by a plurality of computers. The analysis device 4 may be a virtual machine implemented by a computer.

A program for analysis device 4 can be stored on a computer readable recording medium such as an HDD, an SSD, a USB memory, a CD, a DVD, or the like. The computer readable recording medium is, for example, a non-transitory recording medium. The program for analysis device 4 can also be distributed via a communication network.

### REFERENCE SIGNS LIST

1 Optical fiber cable
2 Optical switch
3 Strain distribution measurement device
4 Analysis device
5 Tensile strength member
10, 10a, 10b, 10c Optical fiber
41 Reception unit
42 Arithmetic unit
100 Linear structure
901 CPU
902 Memory
903 Storage
904 Communication device
905 Input device
906 Output device

1. A detection system for detecting a linear structure, using an optical fiber cable including a multi-core optical fiber and having different cross sectional lengths in a vertical direction and a horizontal direction, the detection system comprising:
a strain distribution measurement device configured to measure a strain distribution along an extending direction of a multi-core optical fiber before the optical fiber cable is installed into the linear structure, and to measure a strain distribution along an extending direction of the multi-core optical fiber after the optical fiber cable is installed into the linear structure, and
an analysis device configured to calculate a shape of the optical fiber cable using a difference between the strain distribution before the optical fiber cable is installed and the strain distribution after the optical fiber cable is installed, and to calculate an installation position of the linear structure based on the shape of the optical fiber cable.

2. The detection system according to claim 1, wherein the analysis device is configured to calculate the presence or absence of abnormality, and an installation position of the linear structure, based on a magnitude of a difference between strain distributions measured at two or more different timings after the optical fiber cable is installed into the linear structure.

3. The detection system according to claim 1, wherein the optical fiber cable comprises a plurality of optical fibers including the multi-core optical fiber,
the plurality of optical fibers are fixed in a row.

4. The detection system according to claim 1, wherein the multi-core optical fiber has a clad diameter of 125±1 μm, and includes four or more cores.

5. The detection system according to claim 1, wherein
the optical fiber cable further comprises a single-mode optical fiber including one core at a center of a cross-section, and
the analysis device calculates an installation position of the linear structure, using a strain distribution of the multi-core optical fiber and a strain distribution of the single-mode optical fiber.

6. A detection method for detecting a linear structure, using an optical fiber cable including a multi-core optical fiber and having different cross sectional lengths in a vertical direction and a horizontal direction, the detection method comprising:
measuring a strain distribution along an extending direction of the multi-core optical fiber before the optical fiber cable is installed into the linear structure, by using a strain distribution measurement device,
measuring a strain distribution along an extending direction of the multi-core optical fiber after the optical fiber cable is installed into the linear structure, by using the strain distribution measurement device, and
calculating the shape of the optical fiber cable using a difference between the strain distribution before the optical fiber cable is installed and the strain distribution after the optical fiber cable is installed, and calculating an installation position of the linear structure based on the shape of the optical fiber cable, by using an analysis device.

7. An analysis device, using an optical fiber cable including a multi-core optical fiber and having different cross section lengths in a vertical direction and a horizontal direction, the analysis device comprising:
a reception unit, including one or more processors, configured to receive a strain distribution along an extending direction of the multi-core optical fiber measured before the optical fiber cable is installed into the linear structure, and to receive a strain distribution along an extending direction of the multi-core optical fiber measured after the optical fiber cable is installed into the linear structure, and
an arithmetic unit, including one or more processors, configured to calculate a shape of the optical fiber cable using a difference between the strain distribution before the optical fiber cable is installed and the strain distribution after the optical fiber cable is installed, and to calculate an installation position of the linear structure based on the shape of the optical fiber cable.
